(19) United States
(12) Patent Application Publication
(10) Pub. No.: US 2013/0191222 A1
(43) Pub. Date: Jul. 25, 2013

(54) SOCIAL RELATIONSHIP-BASED TRADING SYSTEM

(71) Applicant: Arman Glodjo, Winnipeg (CA)

(72) Inventor: Arman Glodjo, Winnipeg (CA)

(73) Assignee: OBJECTS IN MIRROR ARE CLOSER THAN THEY APPEAR, LIMITED, Hamilton (BM)

(21) Appl. No.: 13/587,896

(22) Filed: Aug. 16, 2012

Related U.S. Application Data
(60) Provisional application No. 61/524,185, filed on Aug. 16, 2011.

(51) Int. Cl. G06Q 30/02

(52) U.S. Cl. CPC G06Q 30/0269
USPC 705/14.66

(57) ABSTRACT

Techniques are disclosed relating to a marketplace service for a plurality of users that includes a first user and a second user. In one embodiment, a computer system determines whether to present item information from the first user to the second user within the marketplace service, wherein the item information relates to a transaction in an item. This determination may be based on accessed relationship information indicating a social relationship between the first and second users within an information sharing service. The information sharing service may be separate from the marketplace service in some embodiments. The determination whether to present information from the first user to the second user may also be based on credit relationship information pertaining to these users. In one embodiment, the presented item information may relate to a financial instrument.

### CROSS-REFERENCE TO RELATED APPLICATIONS

This application claims the benefit of U.S. Provisional Application Number 61/524,185 (entitled “Social Relationship-Based Trading System” by Arman Glodjo), filed on Aug. 16, 2011, which is incorporated by reference herein in its entirety.

The following U.S. patents and publications are also incorporated by reference herein in their entirety:

U.S. application Ser. No. 11/045,458 entitled “Method And System For Network-Decentralized Trading with Optimal Proximity Measures”; published as U.S. Publ. No. 2005-0131802 on Jun. 16, 2005.

U.S. application Ser. No. 11/045,235 entitled “Single-Period Auctions Network Decentralized Trading System and Method”; issued as U.S. Pat. No. 7,970,689 on Jun. 28, 2011.

U.S. application Ser. No. 11/711,698 entitled “Global Electronic Trading System”; issued as U.S. Pat. No. 7,895,118 on Feb. 22, 2011.

### BACKGROUND

### Technical Field

This disclosure relates generally to computer-facilitated trading of items, and more particularly to trading based on social relationships.

### Description of Related Art

Various computer systems and websites exist that enable users to transact in items. EBAY and AMAZON are just two examples of such systems. Other systems, particularly those that are designed to facilitate transactions in financial instruments, enable such transactions based on indications that credit is extended between the parties.

Various computer systems and websites exist that enable users to establish social relationships with one another. Various social media websites and services such as FACEBOOK, TWITTER, and LINKEDIN are examples of such systems.

### SUMMARY

The present disclosure describes various embodiments of systems, methods, and computer-readable media for facilitating transactions between users of a system or service using social relationship information. For example, systems may disseminate information relating to transactions based on social relationship information. Systems may also facilitate transactions based on both credit information and social relationship information. Still further, systems may facilitate transactions in a financial instrument within a system based on social relationship information.

### BRIEF DESCRIPTION OF THE DRAWINGS

FIG. 1 is a diagram of one embodiment of a computer system that stores credit information.

FIG. 2 is a diagram of one embodiment of a computer system that stores relationship information.

FIG. 3 is a diagram of one embodiment of a computer system that stores both credit information and relationship information.

FIG. 4 is a diagram of one embodiment of a computer system that facilitates transactions based on social relationship information.

FIG. 5 is a diagram of one embodiment of a computer system that permits dissemination of trade information along pathways defined by social relationship information, as well as modification of an item for which a trade is proposed.

FIG. 6 illustrates examples of order books that may be utilized by a computer trading system.

FIG. 7 is a diagram of one embodiment of a computer system configured to implement a single-period auction using social relationship information.

FIG. 8 illustrates an exemplary topology of a social network.

FIG. 9 illustrates an exemplary topology of a social network along with various examples of restrictions on information sharing that may be set.

FIGS. 10A-H illustrate various specific permissioning scenarios between nodes in a social network.

FIG. 11 is a diagram of one embodiment of a computer system configured to consummate trades within the system.

FIG. 12 is a diagram of one embodiment of a computer system configured to convey transactions to an external system for consummation.

FIG. 13 depicts one embodiment of an exemplary computer system.

### DETAILED DESCRIPTION

As used herein, a “relationship” refers to a connection between entities. A relationship thus does not refer solely to an entity's membership in a group. (As used herein, an entity refers broadly to an individual, business, or other organization.) A relationship may be a “direct” relationship between at least two parties, indicating, for example, that the entities know one another, that the entities desire to exchange information, or that there is some other type of connection. A relationship can also be an “indirect” relationship. For example, if entity A has a relationship with entity B, and entity B has a relationship with entity C, entity A and C can be said to have an indirect social relationship via entity B. The relationship between entities A and C can also be said to be a “second-degree” relationship, in contrast to the “first-degree” relationships between A and B and B and C. The present disclosure contemplates relationships of arbitrary social degree. An indirect relationship thus consists of a path with at least two links. Continuing the above example, the indirect relationship between A and C can be considered to correspond to a path between A and C that has two links—one between A and B, and one between B and C. This indirect relationship between A and C can also be said to “pass through” B.

An information sharing service is a computer system that stores or accesses information about users, permits those users to establish relationships with one another via the system, and stores information indicative of the established relationships. FACEBOOK, TWITTER, LINKEDIN, and GOOGLE+are examples of information sharing services. (As is known in the art, a “computer system” can actually refer to a multiplicity of connected computer systems, operating either together or at a distance.) The term “social network” may be used not only to refer to the aggregate connections of an information sharing service, but also to refer to the information sharing service itself. Accordingly, a system like FACEBOOK stores information about a social network, but also is a social network.

This disclosure also refers to an “electronic marketplace” or a “marketplace service.” As used herein, these phrases refer to computer systems that facilitate users entering into a transaction by exchanging information via a network such as the Internet. “Entering into a transaction” includes, for example, one user committing to buy or sell an item to or from another user (e.g., selecting the “BUY IT NOW” feature on EBAY, and confirming purchase). Additionally, an electronic marketplace may allow a user to pay for an item, but this functionality is not required. An electronic marketplace thus includes systems that allow a user to specify an item for purchase and then checkout through the site (e.g., AMAZON), as well as systems that allow the user to commit to purchase an item, with payment for the item being handled separately. Accordingly, a system that permits a user to select an item for purchase and records the transaction also implements an electronic marketplace, even if payment is handled by a separate service such as PAYPAL.

For example, a website such as CRAIGSLIST is not considered to be an electronic marketplace within the meaning of the present disclosure, since this website merely permits visitors to the site to view posted item listings (contact between interested parties and eventual consummation of the transaction is not performed within the CRAIGSLIST website). CRAIGSLIST or other bulletin-board type services do not allow a user to enter into a transaction within the site. Similarly, website functionality that allows a user to indicate that he or she is “interested” in an item advertised by another user of the site does not cause such a website to be considered an “electronic marketplace” within the meaning of the present disclosure. Such functionality does not constitute entering into a transaction, but merely constitutes communicating about an item.

The term “item” is used broadly herein to refer to tangible goods, services, financial instruments, etc.

The notion of a “relationship” that is made within the context of an information sharing service connotes that the parties to a relationship are users of the information sharing service (e.g., the users have an account with the information sharing service), and that, for each link in the relationship path, the parties in that link have consented to the relationship via the service in some way. Accordingly, a relationship within the context of an information sharing service is not met merely by a computer system storing information designating some connection between entities without the entities both being users of the computer system, and without actually permitting the users to establish the relationship.

In one embodiment, a direct relationship may be a one-way relationship in which one user permits other users to establish a relationship with that user without explicitly confirming each and every relationship (e.g., a user of TWITTER “following” another user, or a user of FACEBOOK “liking” another user, such as a business entity). In another embodiment, a direct relationship may be a two-way relationship (e.g., a friend request from a first user of FACEBOOK that must be confirmed by a second user before taking effect). For indirect relationships, individual links may variously be one-way or two-way relationships.

Thus, information stored by a website indicating that John Smith is connected to Mary Smith is not indicative of a relationship within the context of the present disclosure if a) either John or Mary Smith is not a user of the website, and b) both John or Mary Smith have not consented to relationship via the website in some way. Note that if a) is not satisfied, it follows that b) cannot be satisfied, such that failure to meet a) means the information stored by the website is not a relationship within the meaning of the present disclosure.

In its broadest sense, a “social” relationship within the context of an information sharing service is a relationship that is not based on a financial relationship. Accordingly, a “social” relationship does not include a relationship that is based on a “credit” relationship (which may specify, for example, that user A has extended some amount of credit to user B). The existence of a social relationship between users does not preclude a credit relationship—indeed, the present disclosure explicitly contemplates both social and credit relationships for pairs of users.

A “user” of a system or service refers to an entity that has an account with the system or service. In some embodiments, a “user” of the information sharing service is a distinct entity from the service itself. In such embodiments, a social relationship between two users of a service does not refer, for example, to one user merely indicating a desire to receiving communications from, e.g., a website, merchant, or listserv. Stated another way, in such embodiments, the service permits users of the service to establish social relationships with one another, where the service stores information indicative of the social relationship, and where neither of the users is a proxy for the service itself

This specification includes references to “one embodiment,” “an embodiment,” “one implementation,” or “an implementation.” The appearances of these phrases do not necessarily refer to the same embodiment or implementation. Particular features, structures, or characteristics may be combined in any suitable manner consistent with this disclosure.

Further, various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component.

Additionally, the term “based on” is used herein to describe one or more factors that affect a determination. This term does not foreclose additional factors that may affect a determination. That is, a determination may be based solely on those factors or based at least in part on those factors. Consider the phrase “determine A based on B.” While indicating that B is a factor that affects the determination of A, this phrase does not foreclose the determination of A from also being based on C. In other instances, however, this phrase may cover a situation in which A is determined based solely on B.

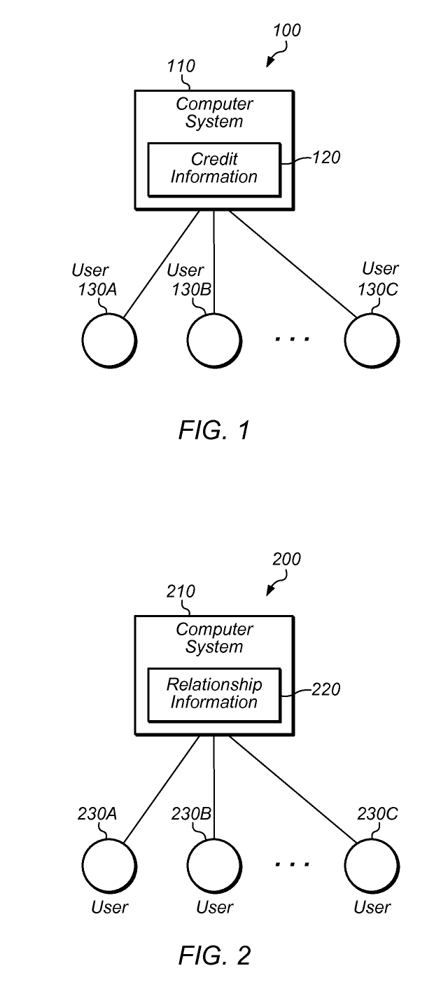

Turning now to FIG. 1, one embodiment of a system 100 that stores credit information 120 is shown. Computer system 110 may facilitate transactions between users of the system (shown as users 130A-C) based on stored credit information 120. It is understood that computer system 100 stores or has access to account information of users 130A-C. As used herein, “facilitation” of a transaction includes, at a minimum, disseminating information describing an item. This disseminated information may include a proposal to trade (i.e., to buy and/or sell) an item. (A proposal to buy and sell an item is pertinent in a number of settings, including those involving financial instruments.) Facilitation of a transaction may also include receiving and storing an indication that a user wishes to purchase an item, matching a trade, clearing or settling a trade, etc.

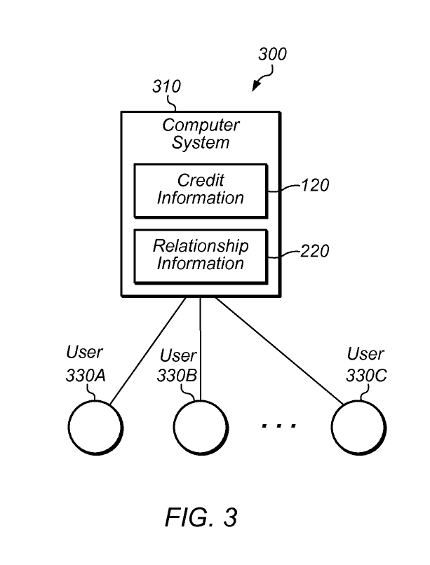

Turning now to FIG. 2, one embodiment of a system 200 that stores relationship information 220 is shown (e.g., for users 230A-C). Computer system 210 may facilitate transactions between users 230 based on relationship information 220, which may, in some instances, be social relationship information. Note that in various embodiments, computer system 200 may either store relationship information 220 itself, or have the ability to access the relationship information from another source (e.g., a third-party service such as FACEBOOK). FIG. 3 depicts one embodiment of a system 300 including a computer system 310 that stores both credit information 120 and relationship information 220 (e.g., for users 330A-C), and can facilitate a transaction based on both types of information. Various embodiments of the general concept shown in FIGS. 2 and 3 are described further below. For example, one possible embodiment is a system that disseminates a proposal to trade based on a social relationship between two users over a social relationship path, and then handles payment for the trade based on a credit relationship between the two users (possibly over a different path).

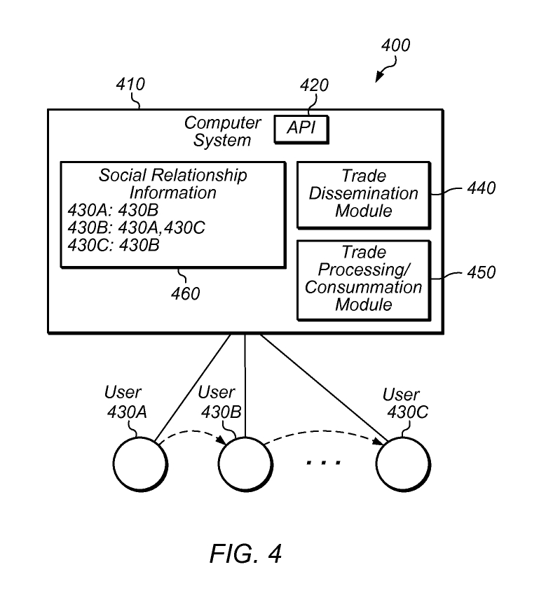

Turning now to FIG. 4, various possible components of one embodiment of a system 400 that facilitates transactions based on social relationship information 460 are shown. FIG. 4 illustrates merely one example of a transaction based on stored social relationship information 460. As indicated, computer system 410 stores social relationship information 460 indicating a social relationship between user 430A and user 430B and between user 430B and user 430C. Trade dissemination module 440 (which may be variously implemented in software, hardware, or a combination thereof) permits trade information (e.g., an offer to sell) originating from user 430A to be disseminated to user 430C. Dissemination module 440 may operate according to permission information and rules that are described further below. (This permission information and rules may be within computer system 410, such as within memory system 1310 described below with reference to FIG. 13. In other embodiments, permission information and rules used by module 440 may be stored in an external location accessible to computer system 410, such as via a local or wide-area network.) In general, permission information and rules may control how trade information can flow through the network. Thus, while the stored social relationship information 460 may indicate that a connection between two entities exists (e.g., there is a connection from user 430A to user 430C via user 430B), permission information and rules may indicate that dissemination of information via that connection is not permitted (e.g., because user 430B does not permit dissemination of user 430A′s information to user 430C, etc.). Further, in the embodiment shown, computer system 410 includes a trade processing/consummation module 450 that allows, in some embodiments, for receiving an indication of a user acting upon (e.g., accepting) a trade. Such a module may also handle processing of an agreed-upon trade. Alternately, such a module may pass further processing to a payment processing module (potentially at another site), or actually handle payment itself Accordingly, in one instance, system 400 facilitates a transaction between user 430A and user 430C based on the common relationship with user 430B that provides an indirect social relationship between user 430A and user 430C. Note that various interactions between computer system 410 and users 430 may be accessed via an application programming interface (API) (e.g., API 420) or other suitable interface.

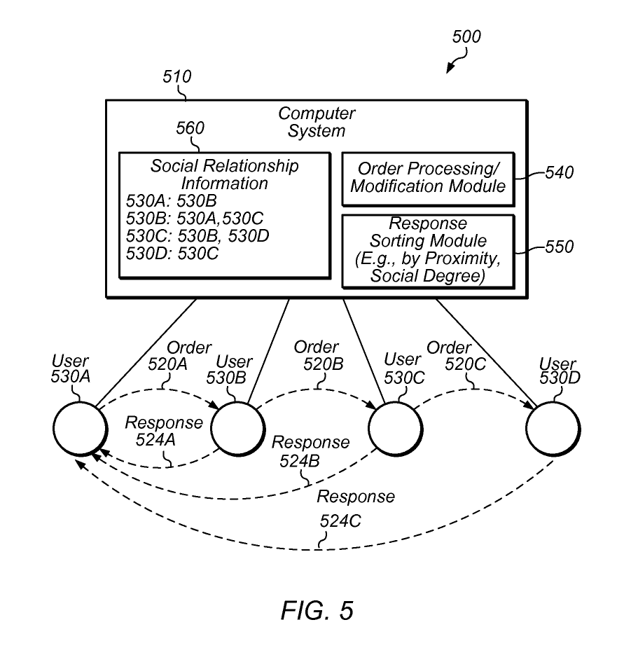

Turning now to FIG. 5, a system 500 is shown that permits, in addition to dissemination of trade information along social pathways defined by stored social relationship information 560, modification of an item for which a trade is proposed. For example, consider order 520A, which, in various embodiments, may be an offer to buy or sell an item, or to buy and sell the item. Thus, in FIG. 5, for the indirect social connection between users 530A and 530D via users 530B and 530C, order 520A may be modified at each node (user) in the path based on rules stored in ordering processing/modification module 540 shown in FIG. 5. Accordingly, for order 520A, user 530A may receive various responses from nodes in the network (e.g., responses 524A-C), where the responses 524 correspond to an item or items other than that originally specified in order 520A (i.e., some property other than the size or price of the original item has been changed). Thus, if order 520A is an offer to buy a black Mont Blanc pen, order 520B may be an offer to buy green Mont Blanc pen, and Order 520C may be an offer to buy a pencil of any color. As such, in certain embodiments, responses 524A-C may include items different from those originally specified in order 520A.

In certain embodiments, a user 530 may specify broad characteristics of an item to be traded (a request to purchase a financial instrument that reduces the volatility of an investment portfolio from x% to y% annualized, a request to purchase a “large” house, etc.). A response to such a request may or may not precisely match the specified criteria, depending on whether other users in the system expand or contract the property search space.

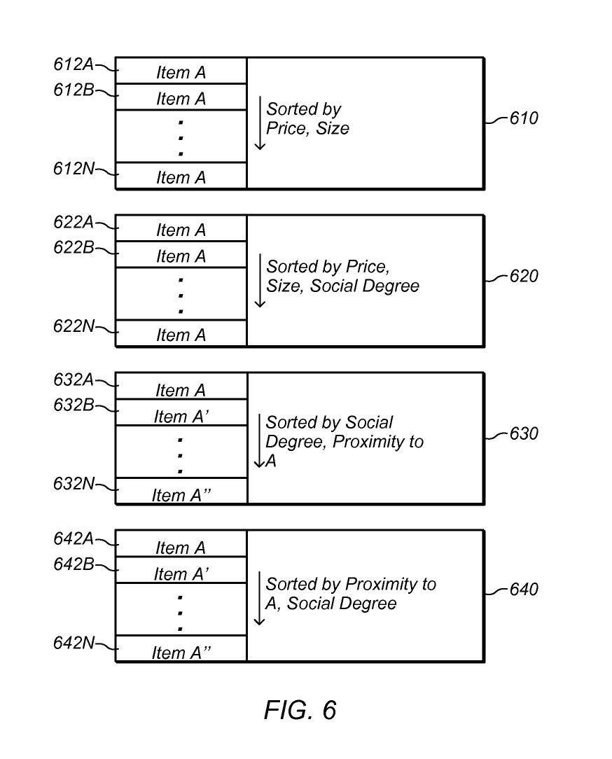

Turning now to FIG. 6, the concept of an “order book” is discussed. In the first example shown in FIG. 6, a set of responses to an order for an item A is shown. As indicated, order book 610 includes a number of entries 612A-N, indicating that an order book may have an arbitrary number of entries. Order book 610 (like the other order books 620, 630, and 640 shown in FIG. 6) may be generated for some particular user. As is typical, the responses in order book 610 (each of which is for item A) are sorted according to price and size, such that the best price at a particular size is shown higher in order book 610 (e.g., entry 612A may indicate a price for item A at a particular size that is better than the price included in entry 612B for item A at the same size). In the second example, order book 620 is additionally sorted according to social degree based on stored social relationship information (e.g., orders from entities having a closer relationship to the user for whom the order book is generated are ordered higher in order book 620). In various embodiments, an order book may be ordered according to different criteria—for example, an order book may be “primarily ordered” by social degree and then “secondarily ordered” by price (that is, all first-degree responses are shown first, and within these first-degree connections, lower prices are shown first). Conversely, an order book may be primarily ordered according to price, and within a given price, secondarily ordered according to social degree. In other situations, an ordering may be based on custom rules individualized by the user, or by another user who originated a piece of information. Various combinations of ordering criteria are possible.

Additionally, to handle the situation in which the order book includes items differing in various respects from the item specified in the original order, the computer system may sort the order book presented to the user based on the proximity of the items in the order book to the originally specified item. Thus if item A is a green Mont Blanc pen, and the responses include a red pencil, a green Mont Blanc pen, and a green pencil, a computer system such as computer system 510 may rank these items in the following order in one embodiment: green Mont Blanc pen, green pencil, red pencil. Any of various proximity sorting algorithms are possible. This ranking based on proximity to A may be combined with ranking based on social degree. The third example in FIG. 6 illustrates an order book 630 primarily ordered based on social degree, and secondarily ordered based on item proximity to item A. The fourth example in FIG. 6 illustrates an order book 640 primarily ordered based on item proximity to item A, and secondarily ordered on social degree.

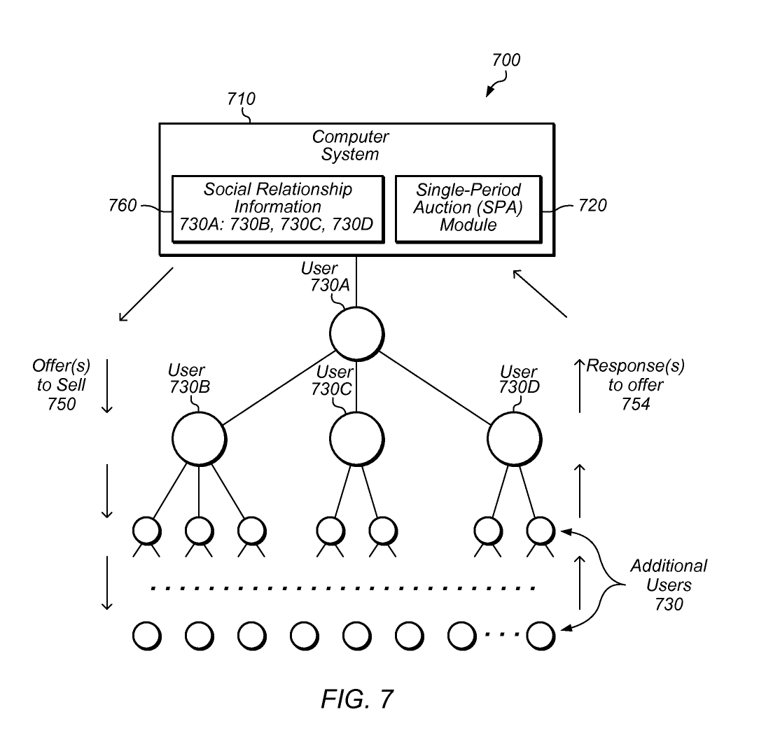

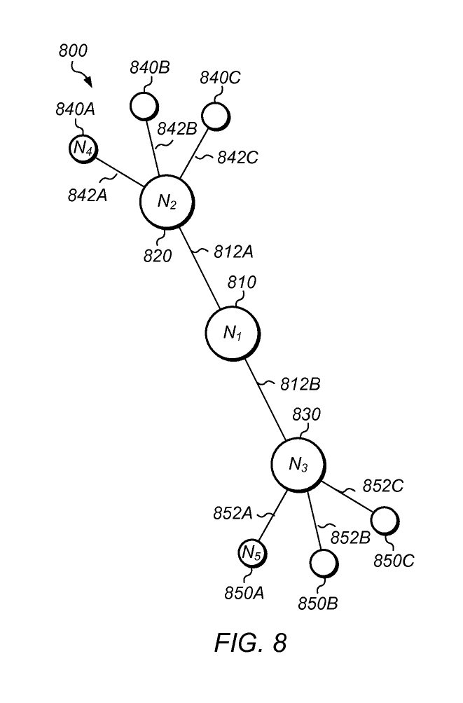

Turning now to FIG. 7, a system 700 configured to implement a single-period auction (SPA) based on social relationship information is shown. As shown, system 700 includes a computer system 710 that stores social relationship information 760 and a single-period auction module 720. Such a SPA may be for any item or items—as one example, the items may be shares of stock in a company, which may be sold as part of an initial public offering (IPO). As indicated in FIG. 7, computer system 710 stores information 760 indicating that users 730B-D all have a relationship with user 730A. Computer system 710 may conduct a SPA on behalf of user 730A by permitting user 730A to receive responses 754 to the items offered for sale via offers 750. During the single auction period, each of users 730B, 730C, and 730D may conduct its own decentralized auction for the items by presenting an offer to additional ones of users 730 for which it has a direct social relationship. Further decentralized auctions may occur throughout the social network. Responses 754 to the various offers 750 are conveyed back through the chain, and are ultimately presented to user 730A by one or more of user 730B, 730C, and 730D. Computer system 710 may then process the received responses in module 720 to determine the results of the single-period auction (e.g., determine the price for the items to be sold). In this manner, a single-period auction may be conducted within a social network.

Turning now to FIG. 8, an exemplary topology of a social network 800 is shown. This depiction illustrates the concept of proximity within the social network by showing how different users may have relationships of different degrees to one another. A computer system that facilitates transactions between users based on such social relationships may store indications of such relationships in any suitable fashion. Additionally, a system that facilitates such transactions may not itself store the social relationship information, but may instead access another computer system to obtain such information. Accordingly, a computer system that implements a marketplace service may use the stored social relationship information of a different service (e.g., an information sharing service such as FACEBOOK) in order to facilitate transactions based on social relationships. Alternately, a computer system may implement both a marketplace service and an information sharing service.

FIG. 8 also illustrates a conceptual distinction between nodes and edges in the social network, and thus the types of information that may be stored relative to a social network. “Nodes” in the network correspond to users of the system; accordingly, a computer system implementing a social network may store information relating to various users of the system, including user profile data, as well as the user's actual information (e.g., information about trades the user is proposing). Nodes are shown in FIG. 8 by reference numerals 810 (node N₁), 820 (node N₂), 830 (node N₃), 840 (including node N₄), and 850 (node N₅). Node information stored and/or used by an associated computer system may include user profile information, user data, and the like.

On the other hand, “edges” in the network correspond to connections between users; accordingly, the computer system may store information relating to various types of connections between users. Edges are shown in FIG. 8 by reference numerals 812A-B, 842A-C, and 852A-C. Edge information stored and/or used by an associated computer system may include credit information, social relationship information (including weight values), permission information, and the like. For example, a computer system may store information indicative of credit relationships between users, including maximum limits and current available flows. Additionally, the computer system may store information indicative of social relationships between users. Note that indications of relationships are not necessarily indicated in a binary fashion, but rather may have associated weight values that determine preferred connections and the like. Still further, the computer system may store permission information that affects the flow of information within the network.

Social network 800 includes relationship of various degrees. For example, the relationship between nodes N₁ and N₂ is a first-degree social relationship since these nodes are directly connected by edge 812A. The social relationship between nodes N₂ and N₃, on the other hand, is a second-degree relationship since these nodes are connected via node N₁. Similarly, the relationships between nodes N₂ and N₅ and between N₄ and N₅ are third- and fourth-degree relationships, respectively.

Because a computer system may access stored relationship information from a third party, there could be multiple information networks used by a given system. For example, a first computer system could store information about users, including a first user and a second user. The first computer system may also store information about a trade proposed by the first user. The first computer system could then access a second computer system to determine whether the second computer system stores information indicating not only that the first and second users are users of the second computer system or associated service, but also that the second computer system indicates that the first and second users have a social relationship. Based on this information, the first computer system may convey the trade proposed by the first user to the second user. If the second user indicates a desire to act upon (e.g., accept) the proposal to trade via the first computer system, the first computer system may clear/settle the trade using information (e.g., credit information) stored on the first computer system, the second computer system, another computer system, or some combination thereof

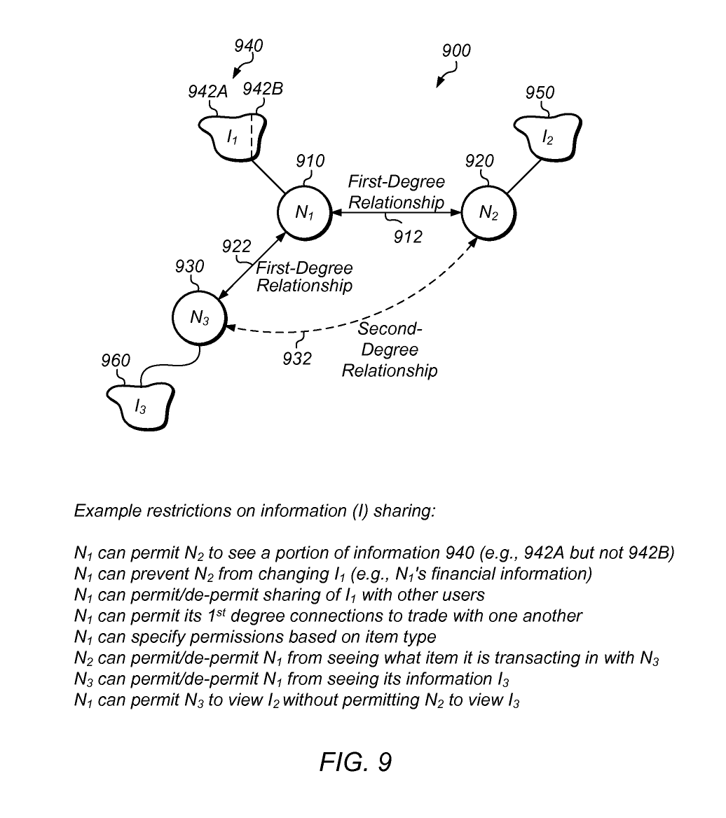

Turning now to FIG. 9, a diagram 900 is shown that further describes permission information that may be implemented by a computer system described by the present disclosure. FIG. 9 depicts nodes N₁, N₂, and N₃, (indicated by reference numerals 910, 920, and 930, respectively). These nodes correspond to respective users of a service. FIG. 9 also depicts information associated with each of these accounts (I₁, I₂, and I₃, respectively, indicated by reference numerals 940, 950, and 960). Information 940 is indicated as having portions 942A and 942B. As shown, N₁ has a first-degree relationship with both N₂ and N₃ (as indicated by edges 912 and 922), such that N₂ and N₃ have a second-degree relationship via N₁ (as indicated by implicit edge 932).

Various types of restrictions on information sharing may be set via a computer system according to the present disclosure. These restrictions include N₁′s ability to control whether other users can view its information I₁. For example N₁ can permit N₂ to see a portion of information 940 (e.g., N₂ can see portion 942A but not portion 942B). Similarly, these restrictions include N₃'s ability to control whether other users can view its information I₃, N₁′s ability to control whether other users can change its information I₁ (for example, N1 might specify that other users cannot change its financial information); N₁'s ability to control sharing of I₁ with other users; N₁'s ability to permit trading among its connections (e.g., N₁ can permit trading between N₂ and N₃, which have a second-degree relationship via Nᵢ); etc. Note that N₁ can selectively permission information—for example, N₁ can determine that N₂ but not N₃ can view I₁. N₁ can set permission based on a type of the item for which information is being disseminated. For example, a computer system may store information indicating that N₁ is more restrictive about disseminating information about certain classes of securities.

These restrictions can also pertain to whether a social intermediary in a transaction (e.g., N₁) can view information about a current trade between two of its connections (e.g., N₂ and N₃). Accordingly, permission information for a first user (e.g., N₁) may allow a transaction between two other users (e.g., N₂ and N₃), while separate permission information (e.g., for N₂) may specify whether the first user may view information that is the subject of the transaction (that is, even though N₁ allows N₂ and N₃ to trade, N₂ may not permit N₁ to know what item N₂ and N₃ are transacting in). Such controls may extend to any arbitrary degree within the social network.

Still further, permission controls according to the present disclosure may allow a first user to specify control over whether second and third users can view each other's information, particularly where a transaction is permitted based on a connection via the first user. Such controls are not necessarily symmetric. Thus, N₁ may permit N₃ to view I₂ without permitting N₂ to view I₃.

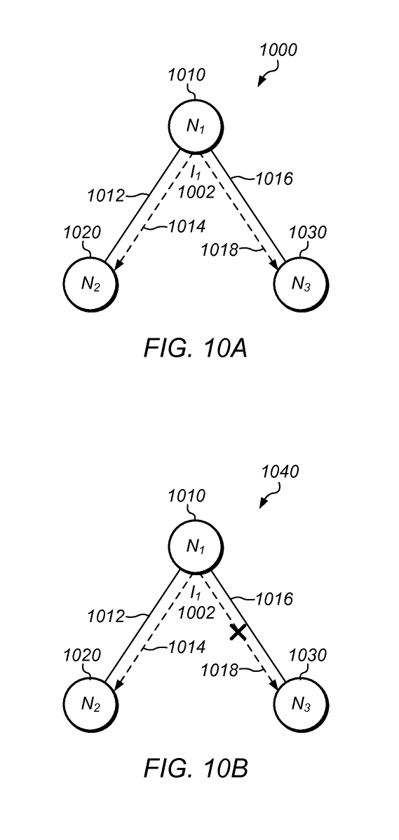

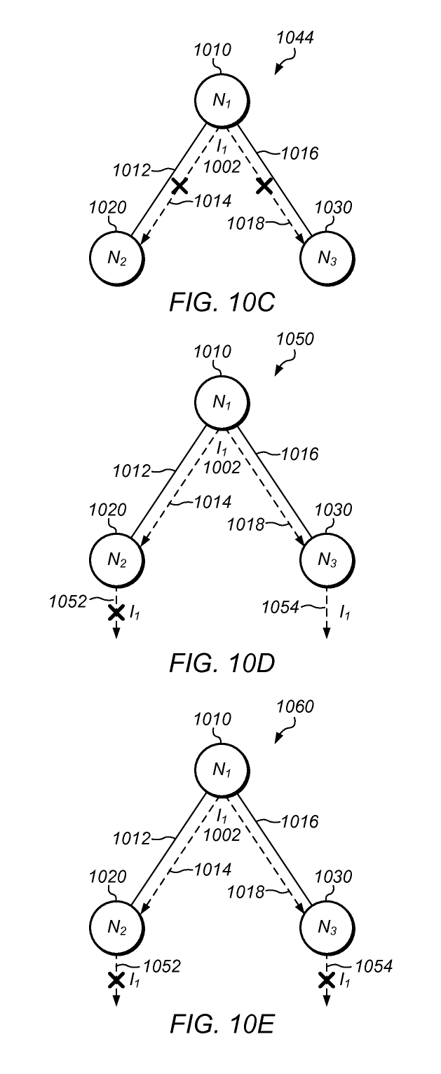

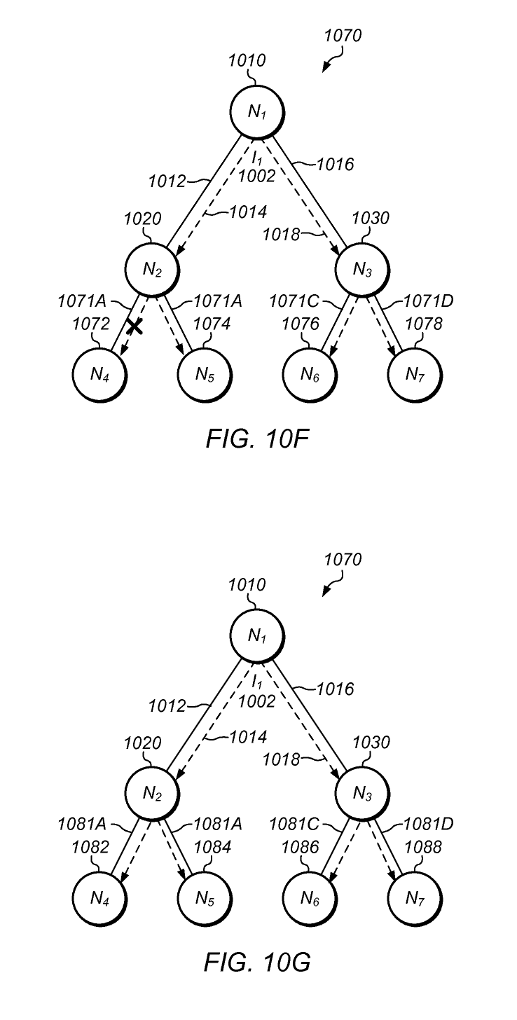

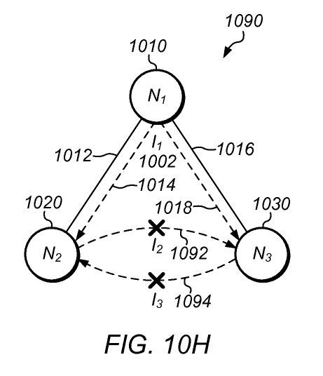

FIGS. 10A-H illustrate various permissioning scenarios in greater detail. In example 1000 shown in FIG. 10A, N₁ (indicated by reference numeral 1010) permits dissemination of its information I₁ (1002) to N₂ (1020) and N₃ (1030), which are connected via edges 1012 and 1016. The dissemination of information 1002 is indicated in FIG. 10A by dotted lines 1014 and 1018. In this particular example, there are no restrictions on N₂ and N₃ disseminating L.

In example 1040 shown in FIG. 10B, N₁ permits dissemination of I₁ to N₂ but not N₃. FIG. 10B is thus labeled similarly to FIG. 10A, except that an “X” on dotted line 1018 means that N₁ does not permit dissemination of I₁ to N₃. In this manner, a user can selectively share its own information with other users. For example, as shown in example 1044 in FIG. 10C, N₁ prohibits dissemination of I₁ to all members of its first-degree network (as indicated by the “X” on dotted lines 1014 and 1018).

Permissioning information may also be used to prevent redistribution of information such as I₁. Such a scenario is illustrated by example 1050 shown in FIG. 10D. In this example, N₁ permits I₁ to be shared with N₂ and N₃. N₁, however, permits only certain ones of its first-degree network (e.g., N₃ but not N₂) to redistribute I₁ to other users. This restriction is indicated by the “X” on dotted line 1052. Unlike the selective second-level dissemination restrictions shown in FIG. 10D, N1 may instead choose to prohibit all second-degree dissemination of I1. Such an arrangement is shown in example 1060 shown in FIG. 10E. This restriction is indicated by the “X's” on dotted lines 1052 and 1054.

Various other permissioning scenarios governing the distribution of I₁ are possible. In one embodiment, illustrated in example 1070 in FIG. 10F, N₁ allows first-degree social relationships to set individual permissions regarding I₁ dissemination. As depicted, N₃ may choose to disseminate I₁ to all of its first-degree social relationships other than N₁ (e.g., nodes N₆ and N₇). Conversely, N₂ may choose to disseminate Iₗ only to selected ones of its first-degree social relationships other than N₁ (e.g., to node N₅ but not node N₄). Still further, N₁ may choose to explicitly choose the degree of dissemination, for example by specifying that N₂ may distribute I₁ only to its first-degree connections (e.g., N₄ and N₅), but that N₃ may distribute I₁ to first- and second-degree connections (e.g., to N₆ and N₇, and their first-degree connections). Alternately, as specified above, N₁ may prevent N₂ and N₃ from any further dissemination of

Example 1090 shown in FIG. 10H illustrates an example of N₁ allowing N₂ and N₃ to see I₁, but not to share other information (e.g., information I₂ of N₂ or information I₃ of N₃) on the basis of the second-degree relationship through N₁. More generally, N₁ can control the flow of information that passes through N₁ to connect nodes (users) having a second-degree or higher social relationship.

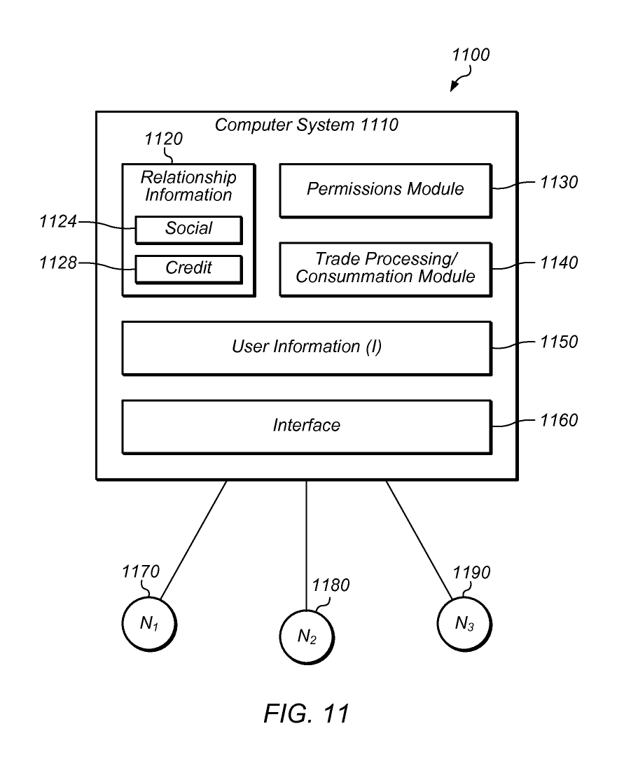

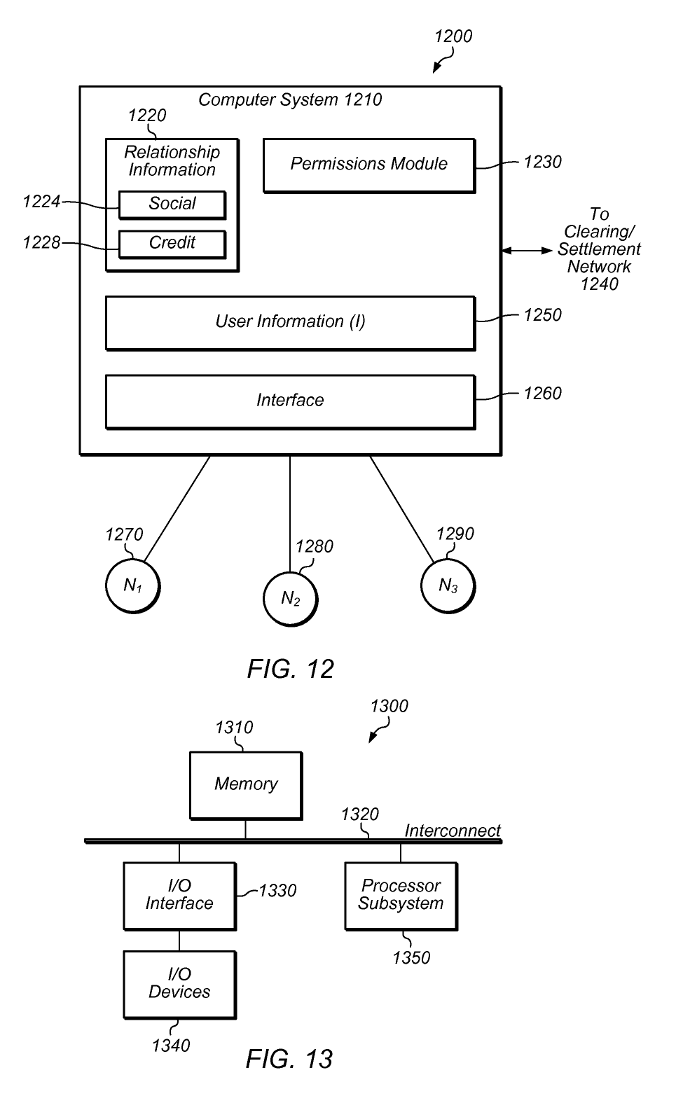

FIGS. 11 and 12 illustrate computer systems that consummate trades in different ways. System 1100 shown in FIG. 11 includes a computer system 1110 having a module 1140 that is executable to consummate trades within system 1100, e.g., by effectuating payment for a transacted-in item. FIG. 12, on the other hand, depicts a system 1200 with a computer system 1210 that passes off transactions for consummation to an external clearing/settlement network 1240. Thus, computer system 1210 may record an indication of a trade (e.g., between users 1270 and 1290), and then send the necessary transaction information to network 1240 for further processing.

### Exemplary Computer System

Turning now to FIG. 13, one embodiment of an exemplary computer system 1300 is depicted. Computer system 1300 includes a processor subsystem 1350 that is coupled to a system memory 1310 and I/O interfaces(s) 1330 via an interconnect 1320 (e.g., a system bus). I/O interface(s) 1330 are coupled to one or more I/O devices 1340. Computer system 1300 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 1300 may also be any type of networked peripheral device such as storage devices, switches, modems, routers, etc. Although a single computer system 1300 is shown for convenience, the system may also be implemented as two or more computer systems operating together.

Processor subsystem 1350 may include one or more processors or processing units. In various embodiments of computer system 1300, multiple instances of the processor subsystem may be coupled to interconnect 1320. In various embodiments, processor subsystem 1350 (or each processor unit within the subsystem) may contain a cache or other form of on-board memory. In one embodiment, processor subsystem 1350 may include one or more processors.

System memory 1310 is usable by processor subsystem 1350. System memory 1310 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 1300 is not limited to primary storage. Rather, computer system 1300 may also include other forms of storage such as cache memory in processor subsystem 1350 and secondary storage on the I/O Devices 1340 (e.g., a hard drive, storage array, etc.). In some embodiments, these other forms of storage may also store program instructions executable by processor subsystem 1350.

I/O interfaces 1330 may be any of various types of interfaces configured to couple to and communicate with other devices, according to various embodiments. In one embodiment, I/O interface 1330 is a bridge chip (e.g., Southbridge) from a front-side to one or more back-side buses. I/O interfaces 1330 may be coupled to one or more I/O devices 1340 via one or more corresponding buses or other interfaces. Examples of I/O devices 1340 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1300 is coupled to a network via a network interface device. The network interface device may be a wireless interface in various embodiments. In other embodiments, computer system 1300 is part of a cloud-based computing service. In general, the present disclosure is not limited to any particular type of computer architecture.

Social relationship information may be used to facilitate transactions using embodiments of the computer systems described above. Exemplary methods implemented by such computer systems are described below.

In one embodiment, a computer system may implement an electronic marketplace service, and within the marketplace service, determine whether to convey trade information (e.g., a proposal to buy and/or sell an item) from one user to another based on relationship information indicating a social relationship between the two users. The relationship information is not necessarily stored by the electronic marketplace service, but may instead be stored by an information sharing service that is distinct from the marketplace service. Thus, the computer system may implement a marketplace website that permits users to consummate transactions based on indications of social relationships stored on another website. Such an embodiment combines marketplace characteristics of a service such as EBAY with social network characteristics of a service such as FACEBOOK.

In another embodiment, a computer system may store account information for a plurality of users, including first, second, and third users. The computer system may be configured to access relationship information indicating a social relationship between the first user and the second user and between the second user and the third user. Based on determining that the first and third users each have a social relationship with the second user, the computer system may present trade information to the third user (or take other actions based on this information). Such a configuration allows the computer system to leverage indirect social relationships between users to facilitate transactions. It is contemplated that the computer system, when presenting trade information to a user, may sort (either primarily, secondarily, etc.) the trade information based on the proximities within the social network between the users from whom the trade information originates and the user to whom trade information is presented.

In another embodiment, a computer system may implement an electronic marketplace that allows users to set permissions for accessing information within the electronic marketplace, wherein the permission relate to social relationships of the users. These permissions may allow, for example, a user to specify that potential trade information originating from other users not having a desired degree of proximity within the social network should not be conveyed. Such permissions permit a user to customize the types of information received within the marketplace, as well as control the flow of the user's own account information within the marketplace.

In another embodiment, a computer system may implement a marketplace service having access to social relationship information. The marketplace service may be implemented such that only users having a direct or indirect social relationship may be permitted to exchange trade information. Alternately, only users having some predetermined proximity within the social network may be permitted to interact (e.g., only users having a third-degree or better relationship may exchange information).

In yet another embodiment, a computer system may facilitate a transaction between a first user and a second user based on both credit information and social connection information available to the computer system. The credit information may indicate a credit relationship between the first and second users, while the social connection information may indicate a social relationship between the first and second users. For example, the computer system may control the flow of trade information in the first instance based on the social relationship information, and may control the actual consummation of a transaction based on the credit information.

In yet another embodiment, a computer system facilitates a transaction for a financial instrument between a first user and a second user based on social connection information accessible to the computer system that indicates a social relationship between the first and second users. In some embodiments, the transaction is also facilitated based on credit information accessible to the computer system that indicates a credit relationship between the first and second users.

### Exemplary Computer-Readable Storage Media

Various methods described herein may be stored on non-transitory (i.e., non-signal) computer-readable media. The phrase “computer-readable media” or “computer-readable storage media” refers to any of a variety of tangible media that store program instructions and/or data used during execution by a computer system. In one embodiment, computer-storage readable media may include various portions of memory subsystem 1310 shown in FIG. 13. In other embodiments, computer-readable storage media may be found within a peripheral storage device such as magnetic (e.g., disk) or optical media (e.g., CD, DVD, and related technologies, etc.). Computer-readable storage media may be either volatile or nonvolatile memory. For example, computer-readable storage media may include (without limitation) FB-DIMM, DDR/DDR2/DDR3/DDR4 SDRAM, RDRAM®, flash memory, and of various types of ROM, etc. Note: as used herein, a computer-readable storage medium is not used to connote only a transitory medium such as a carrier wave, but rather refers to some non-transitory medium such as those enumerated above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the embodiments listed below, as well as the appended claims.

### EMBODIMENTS

Various embodiments have been noted throughout the disclosure. These embodiments include, but are not limited to, the following methods, as well as corresponding computer systems and computer-readable media.

1. A method, comprising:
a computer system implementing a marketplace service for a plurality of users, wherein the plurality of users includes a first user and a second user;
the computer system accessing relationship information indicating a social relationship between the first and second users within an information sharing service, wherein the relationship information is stored by the information sharing service in response to a user-initiated communication within the information sharing service identifying the relationship; and
the computer system determining, based on the accessed relationship information, whether to present item information from the first user to the second user within the marketplace service, wherein the item information relates to a transaction in an item.

2. The method of embodiment 1, wherein the computer system implements the information sharing service and stores the relationship information.

3. The method of embodiment 1, wherein the information sharing system service is a third-party service relative to the marketplace service.

4. The method of embodiment 1, wherein the item information corresponds to a proposal from the first user to buy and/or sell the item.

5. The method of embodiment 4, wherein the item is a financial instrument.

6. The method of embodiment 4, wherein the item is a tangible good.

7. The method of embodiment 1, wherein the social relationship between the first and second users is an indirect social relationship.

8. The method of embodiment 1, wherein the relationship information indicating a social relationship between the first and second users indicates a two-way, direct social relationship.

9. The method of embodiment 4, further comprising:
conveying the item information to the second user; and
recording an indication from the second user agreeing to transact in the item with the first user.

10. The method of embodiment 9, further comprising handling payment for the item between the second user and the first user.

11. The method of embodiment 1, wherein the information sharing service is a service that permits users to establish relationships with other users that are distinct from the information sharing service itself, the method further comprising consummating a transaction for the item between the first and second users.

12. A method, comprising:
a computer system storing account information for a plurality of users, wherein the plurality of users includes a first user, a second user, and a third user, wherein the account information includes, for the first user, trade information relating to a proposal to buy or sell an item;
the computer system accessing relationship information indicating, at an information sharing service, a social relationship between the first user and the second user and between the second user and the third user, wherein the relationship information is stored by the information sharing service in response to user-initiated communications identifying the relationships; and
the computer system determining, based on the accessed relationship information indicating that the first and third users each have a social relationship with the second user, to present the trade information to the third user.

13. The method of embodiment 12, wherein the computer system implements the information sharing service, and wherein the accessed relationship information is accessed within the computer system.

14. The method of embodiment 12, wherein the information sharing service is distinct from a service implemented by the computer system.

15. The method of embodiment 14, wherein the service implemented by the computer system is a marketplace service.

16. The method of embodiment 12, further comprising sorting potential trades presented to a user based on proximity within the social network of the users originating the trades.

17. A method, comprising:
a computer system storing information indicating terms for sale of an item by a first of a plurality of users of the computer system, wherein the plurality of users also includes a second user and a third user;
the computer system accessing relationship information of an information sharing service, wherein the relationship information indicates a social relationship between the first user and the second user and between the second user and the third user, wherein the relationship information is stored by the information sharing service in response to user-initiated communications identifying the relationships; and
the computer system determining, based on the accessed relationship information indicating that the first and third users each have a social relationship with the second user, to present the terms for sale to the third user.

18. A method, comprising:
a computer system implementing an electronic marketplace for a plurality of users, wherein social connection information for the plurality of users is accessible to the computer system, and wherein the social connection information specifies one or more social relationships between users of the plurality of users;
the computer system permitting a user within the plurality of users to set preferences for accessing information within the electronic marketplace, wherein the preferences relate to social connection information of the user.

19. The method of embodiment 18, further comprising:
the computer system storing trade information for the plurality of users; and
the computer system filtering trade information accessible to the user based on the preferences set by the user.

20. The method of embodiment 18, wherein the preferences indicate that the user does not wish to transact within the electronic marketplace with other users not having a minimum degree of social relationship to the user.

21. The method of embodiment 20, wherein the preferences indicate that the minimum degree is a second-degree relationship, such that the computer system does not convey to the user trade information originating from users with greater than a second-degree social relationship to the user.

22. The method of embodiment 18, further comprising:
the computer system facilitating a trade within the electronic marketplace between a pair of users, wherein the social connection information does not specify a direct or indirect social relationship between the pair of users.

23. The method of embodiment 18, wherein the preferences specify whether a second user can view account information of the user that is stored by the computer system.

24. The method of embodiment 18, wherein the preferences specify whether a second user can change account information of the user that is stored by the computer system.

25. The method of embodiment 18, wherein the preferences specify whether a second user can share account information of the user with other users of the computer system.

26. The method of embodiment 18, wherein the preferences specify whether second and third users having corresponding social relationships with the user can trade with one another via the computer system based on the common relationship with the user.

27. The method of embodiment 18, wherein the preferences includes preferences based on item type.

28. A method, comprising:
a computer system implementing an electronic marketplace for a plurality of users, wherein the plurality of users includes a first user and a second user, wherein social connection information for the plurality of users is accessible to the computer system, and wherein the social connection information specifies one or more social relationships between users of the plurality of users, including a social relationship between the first user and the second user; and
the computer system permitting, based on the social relationship between the first and second users, the first user to trade with the second user within the electronic marketplace.

29. The method of embodiment 28, wherein the social relationship between the first and second users is a direct social relationship.

30. The method of embodiment 28, wherein the social relationship between the first and second users is an indirect social relationship.

31. The method of embodiment 28, wherein the electronic marketplace includes auction functionality.

32. The method of embodiment 28, wherein the electronic marketplace permits the first user to accept an offer for an item from the second user.

33. The method, comprising:
a computer system implementing an electronic marketplace for a plurality of users, wherein social connection information for the plurality of users is accessible to the computer system, and wherein the social connection information specifies one or more social relationships between users of the plurality of users; and
the computer system permitting trading between only those ones of the plurality of users for which the social connection information specifies a direct or indirect social relationship.

34. A method, comprising:
a computer system implementing an electronic marketplace for a plurality of users, wherein social connection information for the plurality of users is accessible to the computer system, and wherein the social connection information specifies one or more social relationships between users of the plurality of users;
the computer system ordering a set of trade items to be presented to a user within the plurality of users, wherein the set of trade items originates from other users within the plurality of users, and wherein the set is ordered, at least in part, according to degrees of social relationship between the user and each of the other users as specified by the social connection information; and
the computer system conveying the ordered set of trade items to the user.

35. The method of embodiment 34, wherein trade items originating from other users having a closer social relationship to the user are ranked higher in the set.

36. The method of embodiment 34, wherein the set is primarily ordered according to degrees of social relationship.

37. The method of embodiment 36, wherein the set is secondarily ordered according to price or similarity to an input provided by the user.

38. The method of embodiment 37, wherein the input is a search request.

39. The method of embodiment 37, wherein the input is a user-specified preference.

40. The method of embodiment 34, wherein the set is secondarily ordered according to degrees of social relationship.

41. A method, comprising:
a computer system implementing an electronic marketplace for a plurality of users, wherein social connection information for the plurality of users is accessible to the computer system, and wherein the social connection information specifies one or more social relationships between users of the plurality of users within a social network;
the computer system storing information relating to a set of trade items associated with various ones of the plurality of users; and the computer system ordering the set of the trade items for presentation to a first user of the plurality of users, wherein the ordering is based on respective proximities of the various users to the first user.

42. The method of embodiment 41, wherein the set of trade items is ordered such that trade items having closer respective proximities to the first user are listed to the first user before trade items having relatively further respective proximities.

43. A method, comprising:
a computer system facilitating a transaction between a first user and a second user, wherein the facilitating is based on credit information and social connection information available to the computer system, wherein the credit information indicates a credit relationship between the first and second users, and wherein the social connection information indicates a separate, social relationship between the first and second users.

44. The method of embodiment 43, wherein the facilitating further comprises:
the computer system permitting, based on the social connection information, the first user to receive trade information of the second user.

45. The method of embodiment 44, wherein the facilitating further comprises:
the computer system permitting, based on the credit information, the first user to act upon the received trade information.

46. The method of embodiment 43, wherein the credit relationship is an indirect credit relationship.

47. The method of embodiment 43 or 46, wherein the social relationship is an indirect social relationship.

48. The method of any of embodiments 43 to 47, wherein the transaction is for a financial instrument.

49. A method, comprising:
a computer system facilitating a transaction for a financial instrument between a first user and a second user, wherein the facilitating is based on social connection information accessible to the computer system from a service that permits users to establish social relationships with one another and exchange information based on the established social relationship information, wherein the social connection information indicates a social relationship between the first and second users.

50. The method of embodiment 49, wherein the facilitating is additionally based on credit information accessible to the computer system that indicates a credit relationship between the first and second users.

51. The method of embodiment 50, wherein at least one of the social relationship and credit relationship between the first and second users is an indirect relationship.

52. The method of embodiment 49, wherein the service is a third-party service on which the first and second users have accounts.

53. The method of embodiment 49, wherein the service is implemented by the computer system.

54. The method of embodiment 49, further comprising settling the transaction for the financial instrument between the first and second users.

55. The method of embodiment 49, wherein the financial instrument is a derivative.

56. A method, comprising:
a computer system storing account information for a plurality of users;
the computer system accessing relationship information indicating social relationships between various ones of the plurality of users, wherein the relationship information is stored in response to user-initiated communications identifying the relationships;
the computer system disseminating trading information between users of the computer system based on the accessed relationship information; and the computer system permitting a first user of the computer system to determine whether trading information can be disseminated from a second user to a third user of the computer system based on an indirect social relationship between the second and third users that passes through the first user.

What is claimed is:

1. A method, comprising:
a computer system implementing a marketplace service for a plurality of users, wherein the plurality of users includes a first user and a second user;
the computer system accessing relationship information indicating a social relationship between the first and second users within an information sharing service, wherein the relationship information is stored by the information sharing service in response to a user-initiated communication within the information sharing service identifying the relationship; and
the computer system determining, based on the accessed relationship information, whether to present item information from the first user to the second user within the marketplace service, wherein the item information relates to a transaction in an item.

2. The method of claim 1, wherein the computer system implements the information sharing service and stores the relationship information.

3. The method of claim 1, wherein the information sharing system service is a third-party service relative to the marketplace service.

4. The method of claim 1, wherein the item information corresponds to a proposal from the first user to buy and/or sell the item.

5. The method of claim 4, wherein the item is a financial instrument.

6. The method of claim 4, wherein the item is a tangible good.

7. The method of claim 1, wherein the social relationship between the first and second users is an indirect social relationship.

8. The method of claim 1, wherein the relationship information indicating a social relationship between the first and second users indicates a two-way, direct social relationship.

9. The method of claim 4, further comprising:
conveying the item information to the second user; and
recording an indication from the second user agreeing to transact in the item with the first user.

10. The method of claim 9, further comprising handling payment for the item between the second user and the first user.

11. The method of claim 1, wherein the information sharing service is a service that permits users to establish relationships with other users that are distinct from the information sharing service itself, the method further comprising consummating a transaction for the item between the first and second users.

12. A non-transitory computer-readable storage medium storing program instructions that are computer-executable to:
implement a marketplace service for a plurality of users, wherein the plurality of users includes a first user and a second user;
access relationship information indicating a social relationship between the first and second users within an information sharing service, wherein the relationship information is stored by the information sharing service in response to a user-initiated communication within the information sharing service, wherein the user-initiated communication identifies the relationship; and
determine, based on the accessed relationship information, whether to present item information from the first user to the second user within the marketplace service, wherein the item information relates to a transaction in an item.

13. The computer-readable storage medium of claim 12, wherein the social relationship between the first and second users is a two-way relationship.

14. The computer-readable storage medium of claim 12, wherein the social relationship is an indirect social relationship.

15. The computer-readable storage medium of claim 12, wherein the program instructions are computer-executable to determine whether to present item information from the first user to the second user within the marketplace service based on credit relationship information pertaining to the first and second users.

16. The computer-readable storage medium of claim 15, wherein the presented item information relates to a transaction in a financial instrument.

17. A computer system, comprising:
one or more processors in a processor subsystem;
memory storing program instructions executable by the processor subsystem to:
implement a service for a plurality of users that facilitates users entering into transaction for items via the computer system, wherein the plurality of users includes a first user and a second user;
access relationship information indicating a social relationship between the first and second users within an information sharing service, wherein the relationship information is stored by the information sharing service in response to a user-initiated communication within the information sharing service that identifies the social relationship; and
determine, based on the accessed relationship information, whether to present information of the first user to the second user within the service, wherein the presented information relates to a transaction in an item.

18. The computer system of claim 17, wherein the program instructions are executable to implement the service by allowing the user to process payment for a purchased item within the service.

19. The computer system of claim 17, wherein the program instructions are executable to implement the service by allowing the user to commit to purchase an item within the service, and to pay for the purchased item via a separate service.

20. The computer system of claim 17, wherein the program instructions are executable to implement the service by facilitating users entering into transactions for financial instruments via the computer system.
